(19) United States
(12) Patent Application Publication
(10) Pub. No.: US 2022/0297724 A1
(43) Pub. Date: Sep. 22, 2022

(54) MOBILE OBJECT CONTROL SYSTEM, MOBILE OBJECT CONTROL METHOD, AND STORAGE MEDIUM

(71) Applicant: HONDA MOTOR CO., LTD., Tokyo (JP)

(72) Inventor: Aditya Mahajan, Wako-shi (JP)

(21) Appl. No.: 17/681,859

(22) Filed: Feb. 28, 2022

(30) Foreign Application Priority Data
Mar. 16, 2021 (JP) 2021-042382

(51) Int. Cl. B60W 60/00; B60W 30/095; B60W 40/04; B60W 40/06

(52) U.S. Cl. CPC B60W 60/0011; B60W 60/0015; B60W 60/00274; B60W 30/0956; B60W 40/04; B60W 40/06; B60W 2554/4041; B60W 2554/4042; B60W 2554/4046; B60W 2554/80

(57) ABSTRACT

A mobile object control system includes a recognizer configured to recognize a situation in a periphery of a mobile object, a controller configured to control a behavior of the mobile object based on a situation in the periphery recognized by the recognizer, in which the controller, when there is a plan to move the mobile object to an area that interferes with a scheduled trajectory to which a first mobile object moves, estimates a behavioral characteristic of the first mobile object, sets an attention area according to the estimated characteristic for the first mobile object, and controls the mobile object using the set attention area.

### CROSS-REFERENCE TO RELATED APPLICATION

Priority is claimed on Japanese Patent Application No. 2021-042382, filed Mar. 16, 2021, the content of which is incorporated herein by reference.

### BACKGROUND

### Field of the Invention

The present invention relates to a mobile object control system, a mobile object control method, and a storage medium.

### Description of Related Art

In recent years, study for automatic control of vehicles has been conducted. In this regard, a driving assistance device has been known, which includes an instruction means for instructing a start of automated driving of a host vehicle by an operation of a driver, a setting means for setting a destination of the automated driving, a determination means for determining a mode of automated driving based on whether the destination is set when the instruction means is operated by the driver, and a control means for controlling traveling of vehicles based on the mode of automated driving determined by the determination means, in which the determination means determines the mode of automated driving to be automated driving that travels along a current traveling road of the host vehicle or automatic stop when the destination is not set (PCT International Publication No. WO2011/158347).

### SUMMARY

However, with the conventional technology, it may not be possible to accurately control a vehicle according to a surrounding situation.

The present invention has been made in consideration of such circumstances, and an object thereof is to provide a mobile object control system, a mobile object control method, and a storage medium that can control a mobile object more accurately according to a surrounding situation.

A mobile object control system, a mobile object control method, and a storage medium according to the present invention have adopted the following configuration.

(1): A mobile object control system according to one aspect of the present invention includes a storage device that has stored a program, and a hardware processor, in which the hardware processor executes a program stored in the storage device, thereby recognizing a situation in a periphery of a mobile object, executing control processing of controlling a behavior of the mobile object based on a recognized situation in the periphery, in the control processing, when there is a plan to move the mobile object to an area that interferes with a scheduled trajectory to which a first mobile object moves, estimating a behavioral characteristic of the first mobile object, setting an attention area according to the estimated characteristic for the first mobile object, and controlling the mobile object using the set attention area.

(2): In the aspect of (1) described above, the behavioral characteristic includes a first characteristic with a low degree of attention and a second characteristic with a higher degree of attention than that of the first characteristic, and the hardware processor sets an attention area in the case of the second characteristic to be larger than in the case of the first characteristic.

(3): In the aspect of (2) described above, the hardware processor sets a first attention area in front of the first mobile object when the behavioral characteristic is the first characteristic with a low degree of attention, sets a second attention area in front of the first mobile object and on the mobile object side of the first mobile object in a lateral direction in the front when the behavioral characteristic is the second characteristic with a higher degree of attention than that of the first characteristic, and controls the mobile object using the first attention area or the second attention area that is a set attention area.

(4): In the aspect of (2) described above, the behavioral characteristic includes a third characteristic, which tends to move the first mobile object not to leave a distance from a second mobile object traveling ahead, and a fourth characteristic, which tends to behave friendly to the mobile object, and the hardware processor determines whether the behavioral characteristic is the third characteristic or the fourth characteristic when the behavioral characteristic is the second characteristic and the mobile object is present in the attention area, and controls the mobile object based on a result of the determination.

(5): In the aspect of (4) described above, a processing load for the hardware processor to determine whether the behavioral characteristic is the first characteristic or the second characteristic is smaller than a processing load for the hardware processor to determine whether the behavioral characteristic is the third characteristic or the fourth characteristic.

(6): In the aspect of (5) described above, the hardware processor determines whether the first mobile object has the first characteristic or the second characteristic based on a degree of acceleration or a degree of deceleration of the first mobile object, and determines whether the first mobile object has the third characteristic or the fourth characteristic based on a time at which the first mobile object approaches a reference position set for the second mobile object present in front of the first mobile object.

(7): In the aspect of (4) described above, the hardware processor causes the mobile object to advance in front of the first mobile object when the behavioral characteristic is the fourth characteristic.

(8): In the aspect of (4) described above, the hardware processor stops causing the mobile object to advance in front of the first mobile object when the behavioral characteristic is the third characteristic.

(9): In the aspect of (1) described above, when a first road on which the first mobile object moves is connected to a second road on which the mobile object moves, the second road disappears due to the connection, a second mobile object is present in front of the first mobile object at a predetermined distance away from the first mobile object, and there is a plan to move the mobile object to an area that interferes with a scheduled trajectory to which a first mobile object moves, the hardware processor sets the attention area for the first mobile object, and controls the mobile object using the set attention area.

(10): A mobile object control method according to another aspect of the present invention includes, by a computer, recognizing a situation in a periphery of a mobile object, controlling a behavior of the mobile object based on the recognized situation in the periphery, when there is a plan for causing the mobile object to move to an area that interferes with a scheduled trajectory to which a first mobile object moves, estimating a behavior characteristic of the first mobile object, setting an attention area according to an estimated characteristic for the first mobile object, and controlling the mobile object using the set attention area.

(11): A storage medium according to still another aspect of the present invention is a computer-readable non-transitory storage medium that has stored a program causing a computer to execute recognizing a situation in a periphery of a mobile object, controlling a behavior of the mobile object based on the recognized situation in the periphery, when there is a plan to move the mobile object to an area that interferes with a scheduled trajectory to which a first mobile object moves, estimating a behavioral characteristic of the first mobile object, setting an attention area according to the estimated characteristic for the first mobile object, and controlling the mobile object using the set attention area.

According to (1) to (11), the mobile object control system estimates the behavior characteristic of the first mobile object, sets an attention area according to the estimated characteristic for the first mobile object, and controls a mobile object using the set attention area, thereby controlling the mobile object more accurately according to a surrounding situation.

According to (4) to (8), the mobile object control system recognizes the behavior of the first mobile object in more detail, thereby realizing control of a mobile object according to a characteristic of the first mobile object.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram (part 1) for describing entry processing.

FIG. 4 is a diagram which shows an example of a first attention area set in a first state.

FIG. 5 is a diagram (part 2) for describing entry processing.

FIG. 6 is a diagram which shows an example of a second attention area set in a second state.

FIG. 7 is a diagram (part 3) for describing entry processing.

FIG. 8 is a diagram (part 4) for describing entry processing.

FIG. 9 is a diagram (part 5) for describing entry processing.

FIG. 10 is a diagram (part 6) for describing entry processing.

FIG. 11 is a transition diagram of a driving state.

FIG. 12 is a flowchart which shows an example of a flow of processing executed by an automated driving control device.

### DESCRIPTION OF EMBODIMENTS

In the following description, embodiment of a mobile object control system, a mobile object control method, and a storage medium of the present invention will be described with reference to the drawings. As used throughout this disclosure, the singular forms “a,” “an,” and “the” include plural reference unless the context clearly dictates otherwise. In the present embodiment, the mobile object is described as a vehicle, but it may be applied to another mobile object different from a vehicle.

### First Embodiment

### [Overall Configuration]

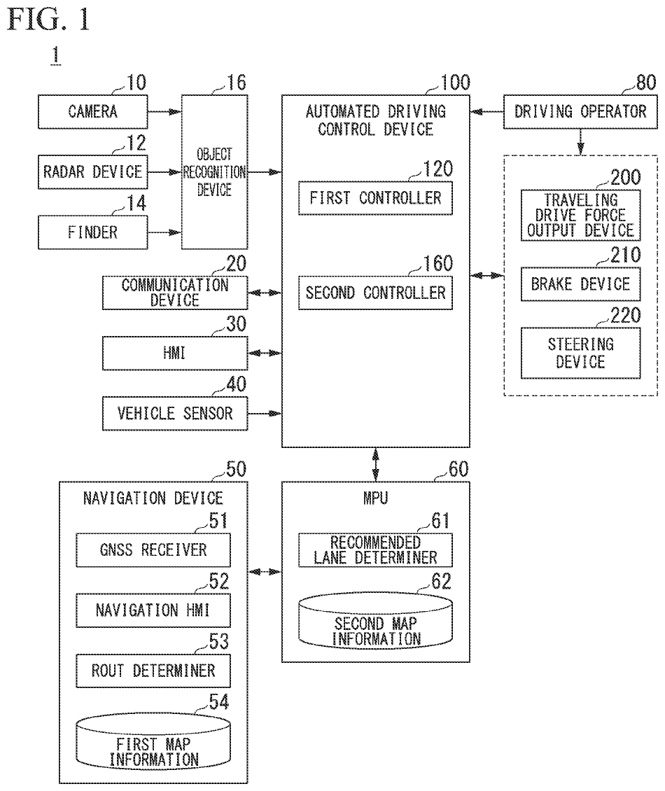

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a host vehicle M). When an image of the front is captured, the camera 10 is attached to an upper part of the front windshield, a back surface of the windshield rear-view mirror, and the like. The camera 10 periodically and repeatedly captures, for example, an image of a periphery of the host vehicle M. The camera 10 may be a stereo camera.

The radar device 12 radiates radio waves such as millimeter waves to the periphery of the host vehicle M, and also detects at least a position (a distance and an orientation) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The finder 14 is a light detection and ranging (LIDAR). The finder 14 irradiates the periphery of the host vehicle M with light and measures scattered light. The finder 14 detects a distance to a target based on a time from light emission to light reception. The irradiated light is, for example, a pulsed laser beam. The finder 14 is attached to an arbitrary place on the host vehicle M.

The object recognition device 16 performs sensor fusion processing on a result of detection by a part or all of the camera 10, the radar device 12, and the finder 14, and recognizes the position, type, speed, and the like of an object. The object recognition device 16 outputs a result of recognition to the automated driving control device 100. The object recognition device 16 may output the results of detection by the camera 10, the radar device 12, and the finder 14 to the automated driving control device 100 as they are. The object recognition device 16 may be omitted from the vehicle system 1.

The communication device 20 communicates with other vehicles present in the periphery of the host vehicle M by using, for example, a cellular network, a Wi-Fi network, Bluetooth (a registered trademark), dedicated short range communication (DSRC), or the like, or communicates with various server devices via a wireless base station.

The HMI 30 presents various types of information to an occupant of the host vehicle M and receives an input operation by the occupant. The HMI 30 includes various display devices, a speaker, a buzzer, a touch panel, a switch, a key, and the like.

The vehicle sensor 40 includes a vehicle speed sensor that detects a speed of the host vehicle M, an acceleration sensor that detects acceleration, a yaw rate sensor that detects an angular speed around a vertical axis, an azimuth sensor that detects a direction of the host vehicle M, and the like.

The navigation device 50 includes, for example, a global navigation satellite system (GNSS) receiver 51, a navigation HMI 52, and a rout determiner 53. The navigation device 50 holds first map information 54 in a storage device such as a hard disk drive (HDD) or a flash memory. The GNSS receiver 51 identifies the position of the host vehicle M based on a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination.

The second map information 62 is map information with higher accuracy than the first map information 54. The second map information 62 includes, for example, information on a center of a lane, information on a boundary of the lane, and the like. The second map information 62 may include road information, traffic regulation information, address information (addresses/zip codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, odd-shaped steering, a joystick, and other operators. The driving operator 80 has a sensor that detects the amount of operation or a presence or absence of an operation attached thereto, and a result of detection is output to the automated driving control device 100, or some or all of the traveling drive force output device 200, the brake device 210, and the steering device 220.

The automated driving control device 100 includes, for example, a first controller 120 and a second controller 160. The first controller 120 and the second controller 160 are realized by, for example, a hardware processor such as a central processing unit (CPU) executing a program (software), respectively. Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the automated driving control device 100, or may be stored in a detachable storage medium such as a DVD or a CD-ROM and installed in the HDD or flash memory of the automated driving control device 100 by the storage medium (non-transitory storage medium) being attached to a drive device.

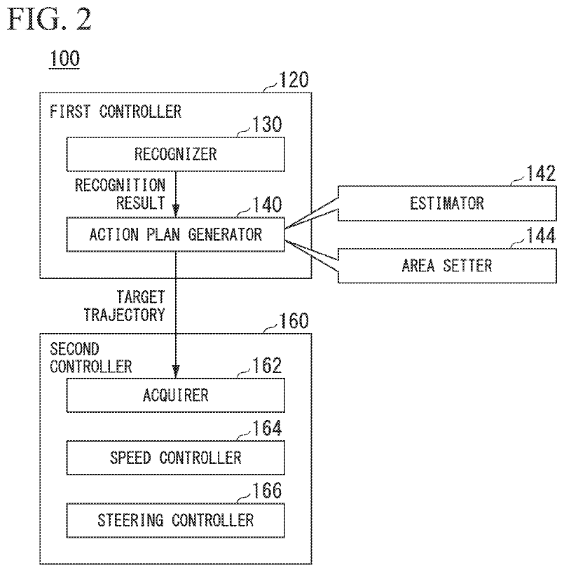

FIG. 2 is a functional configuration diagram of the first controller 120 and the second controller 160. The first controller 120 includes, for example, a recognizer 130 and an action plan generator 140. The first controller 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured. Some of functional units included in the first controller 120 or the second controller 160 may be included in a device different from the automated driving control device 100.

The recognizer 130 recognizes the position of an object in the periphery of the host vehicle M and states such as a speed and acceleration thereof based on information input from the camera 10, the radar device 12, and the finder 14 via the object recognition device 16. The position of an object is recognized as, for example, a position on absolute coordinates with a representative point (a center of gravity, a center of a drive axis, or the like) of the host vehicle M as an origin, and is used for control. The position of an object may be represented by a representative point such as the center of gravity or a corner of the object, or may be represented by an expressed area. The “states” of an object may include the acceleration or jerk of the object, or a “behavioral state” (for example, whether a lane is being changed or is about to be changed).

The recognizer 130 recognizes, for example, a lane (a traveling lane) in which the host vehicle M is traveling. For example, the recognizer 130 recognizes a traveling lane by comparing a pattern of road lane marking (for example, an array of solid lines and broken lines) obtained from the second map information 62 with a pattern of road lane marking in the periphery of the host vehicle M recognized from an image captured by the camera 10. The recognizer 130 may also recognize a traveling lane by recognizing not only the road lane marking but also road boundaries including the road lane marking, a road shoulder, a curb, a median strip, a guardrail, and the like. In this recognition, the position of the host vehicle M acquired from the navigation device 50 and a result of processing by the INS may be taken into account. The recognizer 130 recognizes stop lines, obstacles, red lights, tollhouses, and other road events.

The recognizer 130 recognizes the position and posture of the host vehicle M with respect to a traveling lane when a traveling lane is recognized. The recognizer 130 recognizes, for example, a deviation of a reference point of the host vehicle M from a center of the lane and an angle of the host vehicle M, formed with respect to a line connecting the centers of the lane in the traveling direction, as a relative position and the posture of the host vehicle M with respect to the traveling lane. Instead, the recognizer 130 may recognize the position or the like of the reference point of the host vehicle M with respect to any side end (a road lane marking or road boundary) of the traveling lane as the relative position of the host vehicle M with respect to the traveling lane.

In principle, the action plan generator 140 travels in a recommended lane determined by the recommended lane determiner 61, and, furthermore, generates a target trajectory on which the host vehicle M will automatically travel (regardless of an operation of a driver) in the future to be able to respond to surrounding conditions of the host vehicle M. The target trajectory includes, for example, a speed element. For example, the target trajectory is expressed as a sequence of points (trajectory points) to be reached by the host vehicle M. The trajectory point is a point to be reached by the host vehicle M for each predetermined traveling distance (for example, about several [m]) along a road, and, separately, a target speed and a target acceleration for each predetermined sampling time (for example, about decimal point number [sec]) are generated as a part of the target trajectory. The trajectory point may be a position to be reached by the host vehicle M at a corresponding sampling time for each predetermined sampling time. In this case, information on the target speed and target acceleration is expressed by an interval between trajectory points.

The action plan generator 140 may set an event of automated driving when a target trajectory is generated. The event of automated driving includes a constant-speed traveling event, a low-speed following traveling event, a lane change event, a branching event, a merging event, and a takeover event. The action plan generator 140 generates a target trajectory according to an event to be started.

The action plan generator 140 includes, for example, an estimator 142 and an area setter 144. The action plan generator 140 executes “entry processing” to be described below. Details of these will be described below.

The second controller 160 controls the traveling drive force output device 200, the brake device 210, and the steering device 220 so that the host vehicle M passes through a target trajectory generated by the action plan generator 140 at a scheduled time.

Returning to FIG. 2, the second controller 160 includes, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the traveling drive force output device 200 or the brake device 210 based on a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes feedforward control according to a curvature of a road in front of the host vehicle M and feedback control based on a deviation from the target trajectory in combination.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second controller 160 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the second controller 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second controller 160 or the information input from the driving operator 80, and changes the direction of the steering wheel.

[Entry Processing]

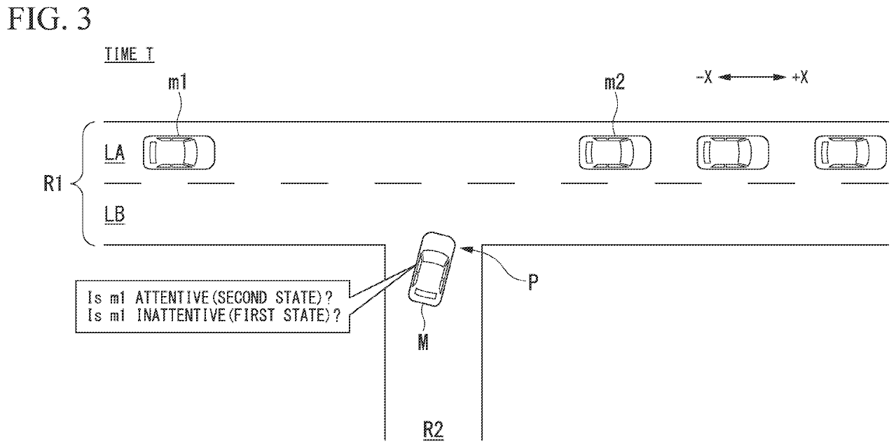

FIG. 3 is a diagram (part 1) for describing entry processing. In FIG. 3, a T-junction is formed by a road R1 and a road R2. The road R2 is a road that intersects with the road R1 and disappears. The road R1 includes a lane LA and a lane LB. The lane LA is a road on which a vehicle proceeding in a positive X direction travels. The lane LB is a road on which a vehicle proceeding in a negative X direction opposite to the positive X direction travels. The lane LB is a lane between the road R2 and the lane LA. Other vehicle m1 and other vehicle m2 are present on the lane LA, and the other vehicle m1 is present behind the other vehicle m2. The other vehicle m1 and the other vehicle m2 are separated from each other by a predetermined distance. The other vehicle m1 is positioned in the negative X direction with respect to the road R2 in an X direction, and the other vehicle m1 is positioned in the positive X direction with respect to the road R2 in the X direction.

The host vehicle M has a plan to proceed from the road R2 to the lane LA. When the host vehicle M reaches a position P at which the road R1 and the road R2 are connected or a vicinity of the position P, the estimator 142 estimates a driving state of the other vehicle m1. An area setter 144 sets an attention area according to the estimated state to the other vehicle m1. The driving state is, in other words, a behavioral characteristic of the vehicle. The action plan generator 140 controls the host vehicle M using the set attention area.

[Driving State]

The driving state includes a first state (inattentive) with a low degree of attention, a second state (attentive) with a higher degree of attention than that of the first state, a third state (aggressive), which tends to move the other vehicle m1 not to leave a distance from the other vehicle m2 traveling in front, and a fourth state (friendly), which tends to cause the other vehicle m1 to perform a friendly action with respect to the host vehicle M. The first state, the second state, the third state, and the fourth state are examples of a “first characteristic,” a “second characteristic,” a “third characteristic,” and a “fourth characteristic,” respectively.

For example, when the other vehicle m1 does not behave to increase the distance from the other vehicle m2 in front of the other vehicle m1 (or when the other vehicle m1 behaves to shorten the distance), the estimator 142 determines that the driving state of the other vehicle m1 is the first state or the third state. For example, when the other vehicle m1 is not decelerating or accelerating, and does not behave to increase the distance from the other vehicle m2, the driving state is the first state or the third state.

The estimator 142 determines that the driving state is the second state or the fourth state when the other vehicle m1 has behaved to increase the distance from the other vehicle m2 in front of the other vehicle m1. For example, when the other vehicle m1 decelerates or the other vehicle m1 does not accelerate and does not behave to shorten the distance from the other vehicle m2, the driving state is the second state or the fourth state.

More specifically, the first to fourth states are states as follows.

First state (inattentive); there is a state in which the other vehicle m1 is performing a normal behavior (a state in which the behavior is not changed from a previous behavior, such as a change in speed and acceleration being the same as a predetermined time before), a state in which the other vehicle m1 follows the other vehicle m2 using a predetermined model, or the like. The predetermined model is, for example, a model for controlling the behavior of other vehicles such as an intelligent driver model (IDM) and adaptive cruise control (ACC), a model for deriving the behavior of a vehicle generated by a learning algorithm, a model using neural network, or the like.

For example, the IDM is a model for obtaining an acceleration at a next time based on a current following state value at each predetermined time. The IDM is, for example, a model in which a speed difference from a vehicle traveling in front, an inter-vehicle distance to be maintained, a desired speed, the maximum acceleration or the maximum deceleration, and the like are used as parameters. For example, the estimator 142 may determine whether the driving state of the other vehicle m1 is the first state based on the behavior of the other vehicle m1 at a predetermined time. The estimator 142 determines, for example, whether the other vehicle m1 is behaving according to a predetermined model based on the behavior of the other vehicle m1 at a predetermined time.

Second state (attentive); there is a state in which the other vehicle m1 is decelerating and adjusting the speed, a state in which the other vehicle m1 leaves an interval from the other vehicle m2 and then follows the other vehicle m2 according to a predetermined model (for example, IDM), or the like.

Third state (aggressive); there is a state in which a time (Headway Time) until the other vehicle m1 approaches a position at a predetermined distance from the other vehicle m2 is equal to or less than a threshold value, and the other vehicle m2 has accelerated. The predetermined distance is, for example, a distance to be maintained according to the IDM, a predetermined inter-vehicle distance, or the like. The threshold value is, for example, a threshold value corresponding to the IDM model such as 0.5 seconds, or a preset threshold value. The preset threshold value may be a threshold value according to a speed statistically obtained based on the speed of a vehicle traveling in a lane.

Fourth state (friendly); there is a state that does not satisfy conditions for the third state. For example, it is a state in which a time until the other vehicle m1 approaches a position at a predetermined distance from the other vehicle m2 exceeds the threshold value, or a state in which the other vehicle m2 is not accelerating.

As described above, whether the driving state is the first state or the second state is determined by a rough standard, and whether it is the third state or the fourth state is determined by a more specific standard than the determination on whether it is the first state or the second state. For example, whether it is the first state or the second state is determined based on the degree of acceleration or the degree of deceleration of the other vehicle m1, and whether it is the third state or the fourth state is determined based on a time at which the other vehicle m1 approaches at a reference position set with respect to the other vehicle m2. For example, the determination on whether it is the third state or the fourth state has a larger processing load for the automated driving control device 100 than the determination on whether it is the first state or the second state. For example, the determination on whether it is the first state or the second state has a smaller processing load for the automated driving control device 100 than the determination on whether it is the third state or the fourth state.

The area setter 144 sets a larger attention area for the other vehicle m1 when the driving state is the second state or the fourth state than when the driving state is the first state or the third state. An attention area is an area in which it is estimated that the other vehicle m1 (a driver of the other vehicle m1) is paying attention (is considering or is careful) in driving. For example, it is estimated that the other vehicle m1 considers an object (for example, the host vehicle M) included in the attention area and does not consider an object (for example, the host vehicle M) outside the attention area.

As shown in FIG. 3, the estimator 142 estimates whether the driving state of the other vehicle m1 is the first state or the second state.

[Setting of First Attention Area]

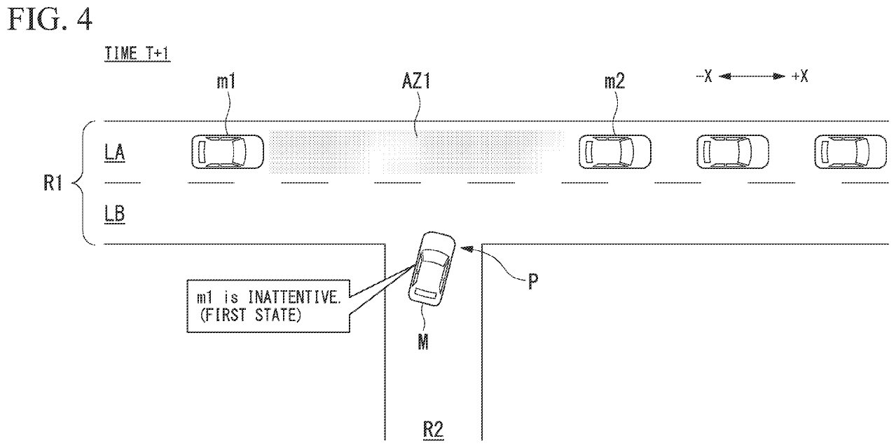

FIG. 4 is a diagram which shows an example of a first attention area AZ1 set in the first state. At a time T+1, when the driving state of the other vehicle m1 is the first state, the area setter 144 sets the first attention area AZ1 in front of the other vehicle m1. The first attention area AZ1 is set in an area between the other vehicle m1 and the other vehicle m2 in the lane LA.

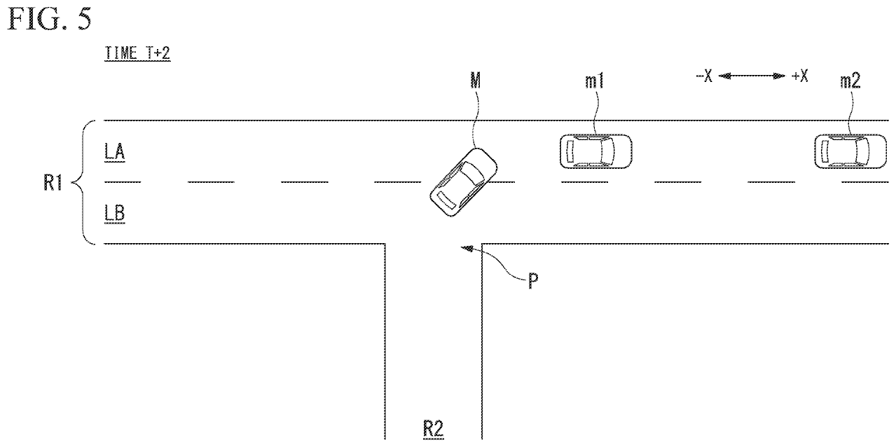

FIG. 5 is a diagram (part 2) for describing entry processing. The action plan generator 140 determines whether the host vehicle M is entering the first attention area AZ1, and, when the host vehicle M is not entering the first attention area AZ1, for example, causes the host vehicle M to proceed to the lane LA after the other vehicle m1 has passed in front of the host vehicle M (the time T+2) or causes the host vehicle M to proceed to the lane LA after the driving state of the other vehicle m1 changes from the second state to the first state. When the driving state of the other vehicle m1 changes to the second state on the way, the action plan generator 140 may cause the host vehicle M to proceed in front of the other vehicle m1. When the host vehicle M is entering the first attention area AZ1, the action plan generator 140 may cause the host vehicle M to enter in front of the other vehicle m1 based on, for example, the behavior of the other vehicle m1 and the position of the host vehicle M. For example, when a vehicle body of the host vehicle M is entering the lane LA by more than a predetermined degree, the host vehicle M may enter the lane LA. “Entry” may mean that a part of a target (the host vehicle M) is entering an area, or may mean that a target is entering an area by more than a predetermined degree.

[Setting of Second Attention Area]

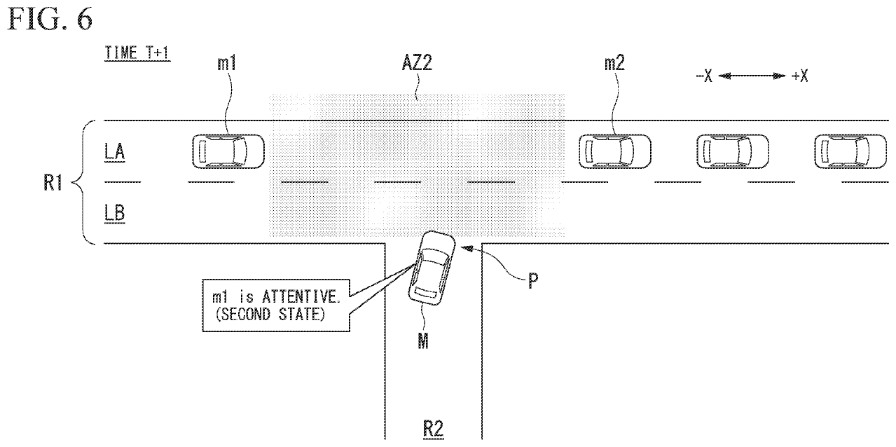

FIG. 6 is a diagram which shows an example of a second attention area AZ2 set in the second state. At the time T+1, when the driving state of the other vehicle m1 is the second state, the area setter 144 sets the second attention area AZ2 in front of the other vehicle m1 and on the host vehicle M side in a lateral direction of the other vehicle m1 in front of the other vehicle m1. The second attention area AZ2 is set in an area between the other vehicle m1 and the other vehicle m2 in the X direction in the lane LA and the lane LB.

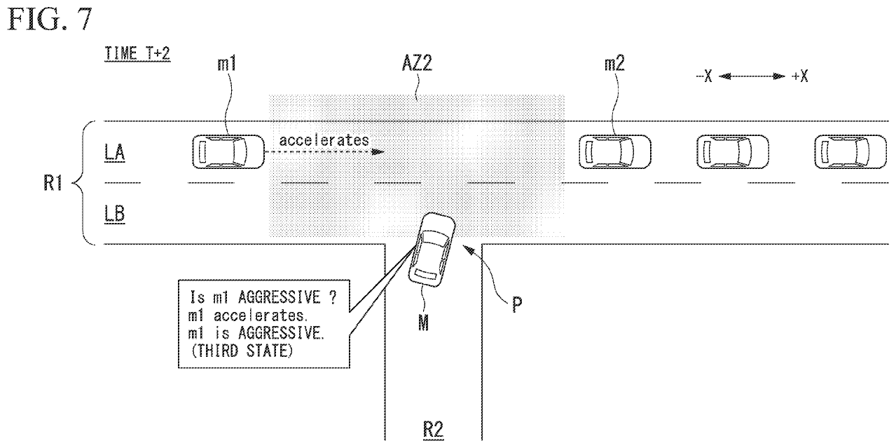

FIG. 7 is a diagram (part 3) for describing entry processing. At the time T+2, the action plan generator 140 determines whether the host vehicle M has entered the second attention area AZ2. When the host vehicle M has entered the second attention area AZ2, the estimator 142 determines whether the driving state of the other vehicle m1 is the third state or the fourth state. For example, when the other vehicle m1 accelerates to approach the other vehicle m2, the estimator 142 estimates that the other vehicle m1 is in the third state. In this case, the action plan generator 140 may, for example, cause the host vehicle M to proceed to the lane LA after the other vehicle m1 passes in front of the host vehicle M, or cause the host vehicle M to proceed to the lane LA after changing the driving state of the other vehicle m1 from the third state to the fourth state (or from the first state to the second state).

As described above, the action plan generator 140 can perform control according to a behavioral characteristic or an intention of the other vehicle m1.

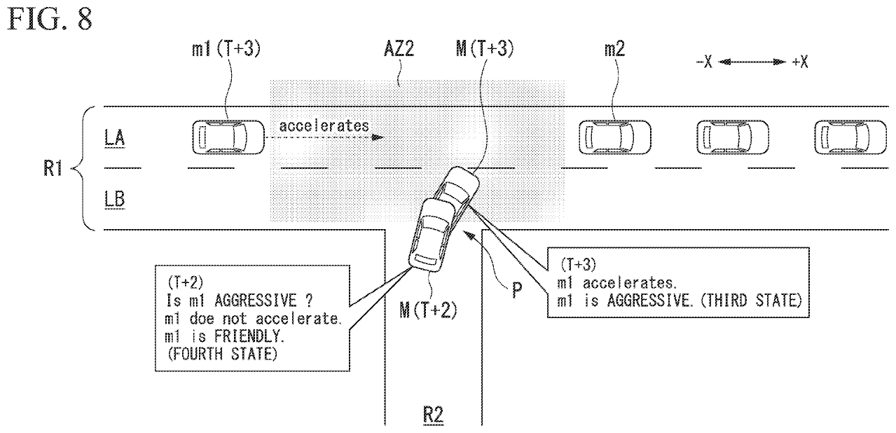

FIG. 8 is a diagram (part 4) for describing entry processing. At the time T+2, when the host vehicle M enters the second attention area AZ2 and the driving state of the other vehicle m1 is the fourth state, the action plan generator 140 controls, for example, the host vehicle M such that it enters in front of the other vehicle m1. When the action plan generator 140 causes the host vehicle M to proceed in front of the other vehicle m1 (when the host vehicle M is present in the second attention area AZ2), the estimator 142 repeats processing of estimating the driving state of the other vehicle m1, and, for example, when it is estimated that the other vehicle m1 accelerates and the driving state is the third state, the action plan generator 140 stops causing the host vehicle M to proceed in front of the other vehicle m1 (a time T+3). Then, the action plan generator 140 causes the host vehicle M to proceed to the lane LA after the host vehicle M passes in front of the other vehicle m1, or causes the host vehicle M to proceed to the lane LA after the driving state of the other vehicle m1 changes from the third state to the fourth state.

As described above, the action plan generator 140 can perform control according to the behavioral characteristic or intention of the other vehicle m1.

As shown in FIGS. 7 and 8 described above, when a state of the other vehicle m1 changes to the third state and the host vehicle M is entering the second attention area AZ2, the estimator 142 may estimate that the driving state is the first state. In this case, the area setter 144 sets the first attention area AZ1. As a result, when the host vehicle M is present in the lane LB at a timing for next processing, the host vehicle M is present outside the first attention area AZ1, so that the action plan generator 140 determines whether the driving state is the first state or the second state without determining whether it is the third state or the fourth state. As a result, the action plan generator 140 can reduce a processing load and appropriately control the host vehicle M according to the state of the other vehicle m1.

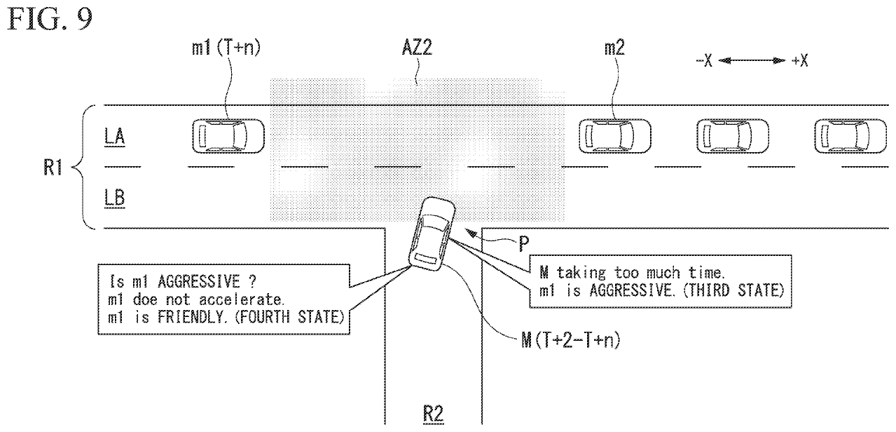

FIG. 9 is a diagram (part 5) for describing entry processing. It is assumed that the host vehicle M enters the second attention area AZ2 and the driving state of the other vehicle m1 is the fourth state. At this time, when the driving state of the other vehicle m1 changes from the fourth state to the third state because, for example, the host vehicle M does not move and stays in a corresponding place, the action plan generator 140 stops, for example, control of causing the host vehicle M to enter in front of the other vehicle m1.

As described above, the action plan generator 140 can perform control according to the behavioral characteristic or changes in intention of the other vehicle m1.

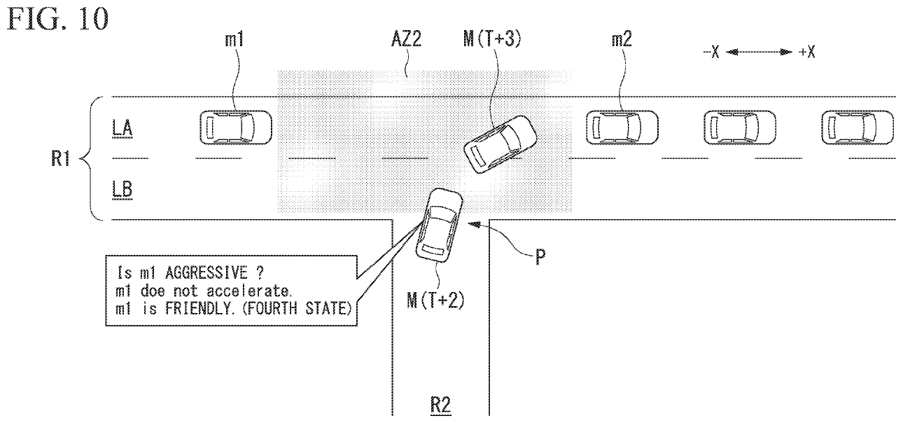

FIG. 10 is a diagram (part 6) for describing entry processing. At the time T+2, when the host vehicle M enters the second attention area AZ2, the driving state of the other vehicle m1 is the fourth state, and the fourth state continues even at a time after the time T+2, the action plan generator 140 controls, for example, the host vehicle M so that it enters in front of the other vehicle m1.

As described above, the action plan generator 140 can perform control according to the behavioral characteristic or intention of the other vehicle m1.

As described above, the action plan generator 140 sets an attention area according to the position of the host vehicle M and the driving state of the other vehicle m1, and, furthermore, controls the host vehicle M based on the attention area, the position of the host vehicle M, and the driving state. As a result, the host vehicle M can respect the driving state of the other vehicle m1 and proceed to the lane LA not to interfere with the other vehicle m1.

For example, when the host vehicle proceeds to the lane LA without performing the setting method of an attention area or the estimation of the driving state as in the present embodiment, a reference and a guideline when the host vehicle is caused to proceed to the lane LA are ambiguous, and thus the control of the host vehicle M may not be performed appropriately. For example, the host vehicle M cannot smoothly proceed to the lane LA or, even if the other vehicle m1 allows the host vehicle M to proceed in front, the host vehicle M may wait for a passage of the other vehicle m1.

On the other hand, the automated driving control device 100 of the present embodiment uses the driving state, an attention area, and the position of the host vehicle M with respect to the attention area as a reference or a guideline as described above, thereby causing the host vehicle M to proceed to the lane LA more smoothly while reducing loads of the other vehicle m1 and the host vehicle M. That is, the automated driving control device 100 of the present embodiment can control the vehicles more accurately according to the surrounding situation.

[Transition Diagram of State]

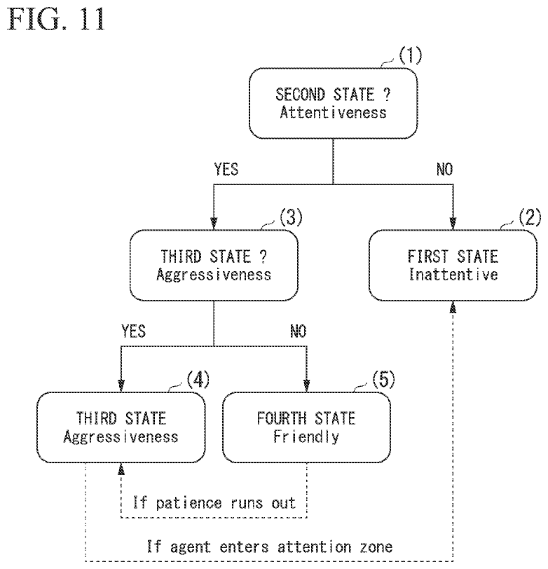

FIG. 11 is a transition diagram of the driving state. (1) First, the estimator 142 estimates whether the driving state of the other vehicle m1 is the second state. (2) When it is estimated that the driving state of the other vehicle m1 is not the second state, the estimator 142 estimates that the driving state of the other vehicle m1 is the first state. In this case, a first attention area is set.

(3) When it is estimated that the driving state of the other vehicle m1 is the second state, the estimator 142 estimates whether the driving state of the other vehicle m1 is the third state. When it is estimated to be the second state, a second attention area is set

(4) When it is estimated that the driving state of the other vehicle m1 is the third state and the host vehicle M is included in the second attention area, the estimator 142 estimates that the driving state of the other vehicle m1 is the first state. When it is estimated to be the first state, a first attention area is set.

(5) When it is estimated that the driving state of the other vehicle m1 is the fourth state and the behavior of the host vehicle M for entering in front of the other vehicle m1 is delayed, the estimator 142 estimates that the driving state of the other vehicle m1 is the third state.

As described above, the estimator 142 estimates the driving state of the other vehicle m1 based on a current driving state of the other vehicle m1 and the behavior of the other vehicle m1. As a result, the action plan generator 140 can appropriately set an attention area used for control of the host vehicle M.

[Flowchart]

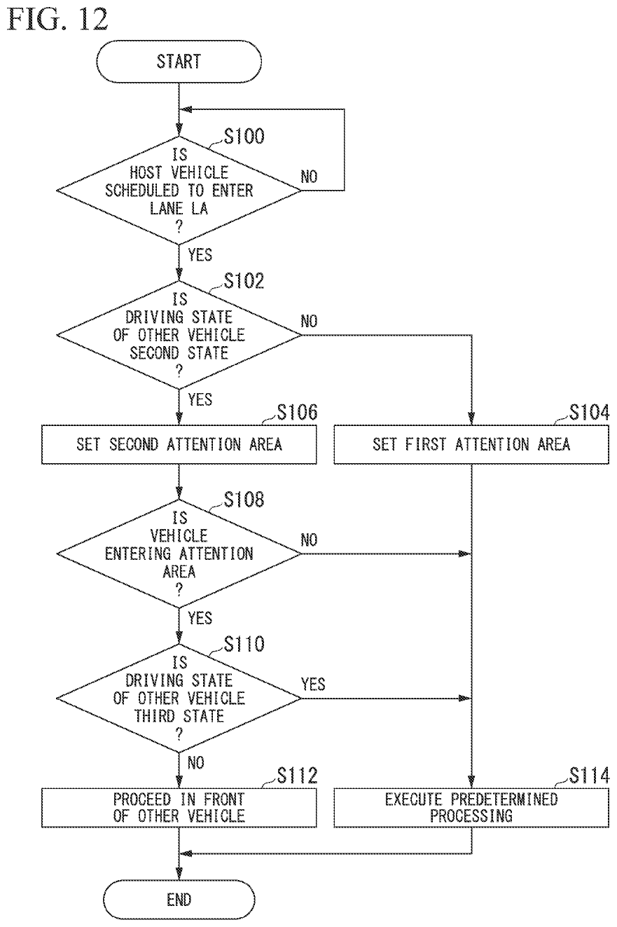

FIG. 12 is a flowchart which shows an example of a flow of processing executed by the automated driving control device 100. First, the action plan generator 140 determines whether the host vehicle M is scheduled to enter the lane LA (step S100). When the host vehicle M is scheduled to enter the lane LA, the estimator 142 determines whether the driving state of the other vehicle m1 is the second state (step S102).

When it is estimated that the driving state of the other vehicle m1 is not the second state (the first state), the area setter 144 sets a first attention area (step S104). Then, predetermined processing is performed (step S114). The predetermined processing is, for example, processing in which the action plan generator 140 causes the host vehicle M to approach the lane LA or to stand by at a corresponding position based on positions of the first attention area and the host vehicle M.

When it is estimated that the driving state of the other vehicle m1 is the second state, the area setter 144 sets a second attention area (step S106). Next, the action plan generator 140 determines whether the host vehicle M is entering the second attention area (step S108). When the host vehicle M is not entering the second attention area, the action plan generator 140 causes, for example, the host vehicle M to approach the lane LA or to stand by at a corresponding position (step S114). That is, predetermined processing is performed.

When the host vehicle M is entering the second attention area, the estimator 142 estimates whether the driving state of the other vehicle m1 is the third state (step S110). When it is estimated that the driving state of the other vehicle m1 is not the third state (when the driving state of the other vehicle m1 is the fourth state), the action plan generator 140 causes the host vehicle M to enter in front of the other vehicle m1 (step S112). When it is estimated that the driving state of the other vehicle m1 is the third state, the action plan generator 140 causes the host vehicle M to approach the lane LA or to stand by at a corresponding position (step S114). That is, predetermined processing is performed. As a result, processing of one routine of this flowchart ends.

As described above, the automated driving control device 100 estimates the driving state of the other vehicle m1 and sets an attention area according to the estimated state. Then, the automated driving control device 100 can control the behavior of the host vehicle M more appropriately by controlling the behavior of the host vehicle M based on the position of the host vehicle M with respect to the attention area.

In the present embodiment, control in a situation where the host vehicle M enters the lane LA on the T-junction has been described, but, instead of this (or in addition thereto), it may be applied on a predetermined road without a signal. For example, processing of the present embodiment may be applied to an intersection, or may be applied when the host vehicle M changes lanes to the lane LA while the vehicle M is traveling in the lane LB.

According to the embodiment described above, the automated driving control device 100 estimates the behavioral characteristic of the other vehicle when there is a plan to move the host vehicle M to an area that interferes with a scheduled trajectory to which the other vehicle moves, sets an attention area according to the estimated characteristic for the other vehicle m1, and controls the other vehicle using the set attention area, thereby controlling a mobile object more accurately according to the surrounding situation.

Although a mode for carrying out the present invention has been described above using the embodiment, the present invention is not limited to the embodiment, and various modifications and substitutions can be made within a range not departing from the gist of the present invention.

What is claimed is:

1. A mobile object control system comprising:
a storage device that has stored a program; and
a hardware processor,
wherein the hardware processor executes a program stored in the storage device, thereby
recognizing a situation in a periphery of a mobile object,
executing control processing of controlling a behavior of the mobile object based on a recognized situation in the periphery,
in the control processing,
when there is a plan to move the mobile object to an area that interferes with a scheduled trajectory to which a first mobile object moves,
estimating a behavioral characteristic of the first mobile object, setting an attention area according to the estimated characteristic for the first mobile object, and
controlling the mobile object using the set attention area.

2. The mobile object control system according to claim 1,
wherein the behavioral characteristic includes a first characteristic with a low degree of attention and a second characteristic with a higher degree of attention than that of the first characteristic, and
the hardware processor sets an attention area in the case of the second characteristic to be larger than in the case of the first characteristic.

3. The mobile object control system according to claim 2,
wherein the hardware processor sets a first attention area in front of the first mobile object when the behavioral characteristic is the first characteristic with a low degree of attention,
sets a second attention area in front of the first mobile object and on the mobile object side of the first mobile object in a lateral direction in the front when the behavioral characteristic is the second characteristic with a higher degree of attention than that of the first characteristic, and
controls the mobile object using the first attention area or the second attention area that is a set attention area.

4. The mobile object control system according to claim 2,
wherein the behavioral characteristic includes a third characteristic, which tends to move the first mobile object not to leave a distance from a second mobile object traveling ahead, and a fourth characteristic, which tends to behave friendly to the mobile object, and
the hardware processor determines whether the behavioral characteristic is the third characteristic or the fourth characteristic when the behavioral characteristic is the second characteristic and the mobile object is present in the attention area, and controls the mobile object based on a result of the determination.

5. The mobile object control system according to claim 4,
wherein a processing load for the hardware processor to determine whether the behavioral characteristic is the first characteristic or the second characteristic is smaller than a processing load for the hardware processor to determine whether the behavioral characteristic is the third characteristic or the fourth characteristic.

6. The mobile object control system according to claim 5,
wherein the hardware processor determines whether the first mobile object has the first characteristic or the second characteristic based on a degree of acceleration or a degree of deceleration of the first mobile object, and
determines whether the first mobile object has the third characteristic or the fourth characteristic based on a time at which the first mobile object approaches a reference position set for the second mobile object present in front of the first mobile object.

7. The mobile object control system according to claim 4,
wherein the hardware processor causes the mobile object to advance in front of the first mobile object when the behavioral characteristic is the fourth characteristic.

8. The mobile object control system according to claim 4,
wherein the hardware processor stops causing the mobile object to advance in front of the first mobile object when the behavioral characteristic is the third characteristic.

9. The mobile object control system according to claim 1,
wherein, when a first road on which the first mobile object moves is connected to a second road on which the mobile object moves, the second road disappears due to the connection,
a second mobile object is present in front of the first mobile object at a predetermined distance away from the first mobile object, and there is a plan to move the mobile object to an area that interferes with a scheduled trajectory to which a first mobile object moves, and
the hardware processor sets the attention area for the first mobile object, and controls the mobile object using the set attention area.

10. A mobile object control method comprising:
by a computer,
recognizing a situation in a periphery of a mobile object;
controlling a behavior of the mobile object based on the recognized situation in the periphery;
when there is a plan for causing the mobile object to move to an area that interferes with a scheduled trajectory to which a first mobile object moves,
estimating a behavior characteristic of the first mobile object;
setting an attention area according to an estimated characteristic for the first mobile object; and
controlling the mobile object using the set attention area.

11. A computer-readable non-transitory storage medium that has stored a program causing a computer to execute:
recognizing a situation in a periphery of a mobile object;
controlling a behavior of the mobile object based on the recognized situation in the periphery;
when there is a plan to move the mobile object to an area that interferes with a scheduled trajectory to which a first mobile object moves,
estimating a behavioral characteristic of the first mobile object;
setting an attention area according to the estimated characteristic for the first mobile object; and
controlling the mobile object using the set attention area.
